(19) United States
(12) Patent Application Publication
(10) Pub. No.: US 2008/0174588 A1
(43) Pub. Date: Jul. 24, 2008

(54) DISPLAY DEVICE AND METHOD THEREOF

(75) Inventors: Hye-Sung KIM, Busan (KR); Hye-Sun CHO, Bucheon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 11/946,117

(22) Filed: Nov. 28, 2007

(30) Foreign Application Priority Data
Jan. 19, 2007 (KR) 1020070005987

(51) Int. Cl. G09G 3/00

(52) U.S. Cl. 345/211

(57) ABSTRACT

A display device includes pixels and a driving voltage generator. A common voltage, including a first common voltage and a lower second common voltage, is applied to the pixels. The driving voltage generator generates first and second voltages from a basic voltage, generates the first common voltage based on the basic voltage and the second voltage, and generates the second common voltage based on the basic voltage and the first voltage. The driving voltage generator includes a voltage distribution unit outputting first and second reference voltages, a first output unit amplifying the first reference voltage and generating the first common voltage, and a second output unit outputting the second common voltage based on the second reference voltage. The first output unit includes an operation amplifier connected to a first power source applied with the second voltage.

This application claims priority to Korean Patent Application No. 10-2007-0005987, filed on Jan. 19, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a display device and a method thereof. More particularly, the present invention relates to a display device capable of preventing driving noise, and a method of preventing driving noise of the display device.

(b) Description of the Related Art

A liquid crystal display (“LCD”) device, one of the commonly used flat panel displays, includes two display panels on which field generating electrodes such as pixel electrodes and a common electrode are formed, and a liquid crystal layer interposed therebetween. In the LCD device, voltage is applied to the field generating electrodes to generate an electric field on the liquid crystal layer to thereby determine an alignment of liquid crystal molecules of the liquid crystal layer and control polarization of incident light, thereby allowing displaying of images.

The LCDs also include switching elements connected to the individual pixel electrodes, and a plurality of signal lines, such as gate lines and data lines, for controlling the switching elements so as to apply voltages to the pixel electrodes.

In the LCD, in order to prevent a degradation phenomenon that occurs when the electric field is applied in the liquid crystal layer in one direction for a long time, polarities of the data voltage with respect to a common voltage are inverted for every frame, every row, or every dot, or the data voltage and the common voltage are inverted.

In addition, the thickness of mobile electronic devices including mobile phones is becoming slimmer. As the thickness decreases, noise is considerably increased as compared to a thicker device. Generally, the noise is generated when a small and midsize display device mounted on the mobile phone is driven. The driving noise is eliminated in a conventional mobile electronic device since the mobile electronic device has sufficient thickness, but the noise may be perceived from outside of the device as the thickness decreases.

### BRIEF SUMMARY OF THE INVENTION

The present invention provides a display device for preventing noise. The present invention also provides a method of preventing noise in a display device.

An exemplary display device according to an embodiment of the present invention includes a plurality of pixels and a driving voltage generator. A common voltage that is a periodic signal including a first common voltage and a second common voltage that is lower than the first common voltage is applied to the plurality of pixels. The driving voltage generator generates first and second voltages from a received basic voltage, generates the first common voltage based on the basic voltage and the second voltage, and generates the second common voltage based on the basic voltage and the first voltage. The driving voltage generator includes a voltage distribution unit for dividing the basic voltage and outputting first and second reference voltages, a first output unit which amplifies the first reference voltage and generates the first common voltage, and a second output unit which outputs the second common voltage based on the second reference voltage. The first output unit includes an operation amplifier connected to a first power source, and the second voltage is applied to the first power source.

The pixel among the plurality of pixels may include a pixel electrode and a thin film transistor (“TFT”) connected to the pixel electrode, the TFT is turned on by receiving a gate signal including a gate-on voltage and a gate-off voltage, and a data voltage is transmitted to the pixel electrode through the TFT. The second voltage may be the same as the gate-on voltage. A third voltage may be generated by the driving voltage generator, and the third voltage may be a gate-off voltage.

The exemplary display device may further include a first resistor connected between an output terminal and an inversion input terminal (−) of the operation amplifier, and a second resistor connected between the inversion input terminal (−) and a ground terminal of the operation amplifier. The first output unit may receive the first reference voltage controlled by a controller, perform non-inversion amplification according to a ratio of the first and second resistors within a range of the first power source and a grounded second power source, and output the first common voltage.

The operation amplifier may be connected to a second power source, and the second power source may be grounded.

The second output unit may include a voltage follower. The voltage follower may be connected to third and fourth power sources, the first voltage may be applied to the third power source, and the fourth power source may be grounded.

The voltage distribution unit may include a resistor string including a plurality of resistors. The exemplary display device may further include a controller which controls the first and second reference voltages output from the voltage distribution unit, and respectively transmits controlled first and second reference voltages to the first and second output units. The controller may include a plurality of transmission gates.

The exemplary display device may include a filter unit connected to at least one of the first and second output units.

The exemplary display device may include a gray voltage generator which generates a reference gray voltage from the first voltage, and a data driver which selects a gray voltage from the reference gray voltage to generate the data voltage.

A frequency of the common voltage may be greater than about 15 KHz. The first common voltage may be set to be within a range of about 8V to about 12V.

An exemplary method of substantially preventing driving noise of a display device according to an embodiment of the present invention includes applying a common voltage to a plurality of pixels, the common voltage being a periodic signal including a first common voltage and a second common voltage lower than the first common voltage, and having a frequency greater than about 15 KHz.

The method may further include, prior to applying the common voltage to the plurality of pixels, generating first and second voltages from a basic voltage received by a driving voltage generator, the second voltage boosted in a positive direction from the first voltage, dividing the basic voltage and outputting first and second reference voltages from a voltage distribution unit, amplifying the first reference voltage in a first output unit with an operation amplifier connected to a first power source, the second voltage applied to the first power source, outputting the first common voltage from the first output unit, and outputting the second common voltage based on the second reference voltage from a second output unit.

### BRIEF DESCRIPTION OF THE DRAWINGS

Exemplary embodiments of the present invention will now be described in detail with reference to the accompanying drawings for a clear understanding of aspects, features, and advantages of the present invention, wherein:

FIG. 1 is an exploded perspective view of an exemplary LCD according to an exemplary embodiment of the present invention;

FIG. 2 is a block diagram of the exemplary LCD according to the exemplary embodiment of the present invention;

FIG. 3 is a diagram of an equivalent circuit for one exemplary pixel of the exemplary LCD according to the exemplary embodiment of the present invention;

FIG. 4 is a diagram representing voltage generation in an exemplary driving voltage generator of the exemplary LCD according to the exemplary embodiment of the present invention;

FIG. 5 is a block diagram representing a part of the exemplary driving voltage generator according to the exemplary embodiment of the present invention;

FIG. 6 is a circuit diagram representing a part of the exemplary driving voltage generator according to the exemplary embodiment of the present invention;

FIG. 7A is a waveform diagram representing a common voltage Vcom1 and a data voltage Vd1 of a conventional LCD of the prior art;

FIG. 7B is a waveform diagram representing the common voltage Vcom and the data voltage Vd of the exemplary LCD according to the exemplary embodiment of the present invention;

FIG. 8A is a graph representing noise according to the audible frequency in the conventional LCD of the prior art to which the common voltage Vcom1 shown in FIG. 7A is applied; and,

FIG. 8B is a graph representing noise according to the audible frequency in the exemplary LCD to which the common voltage Vcom shown in FIG. 7B is applied.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

A liquid crystal display (“LCD”) according to an exemplary embodiment of the present invention will now be described with reference to the figures.

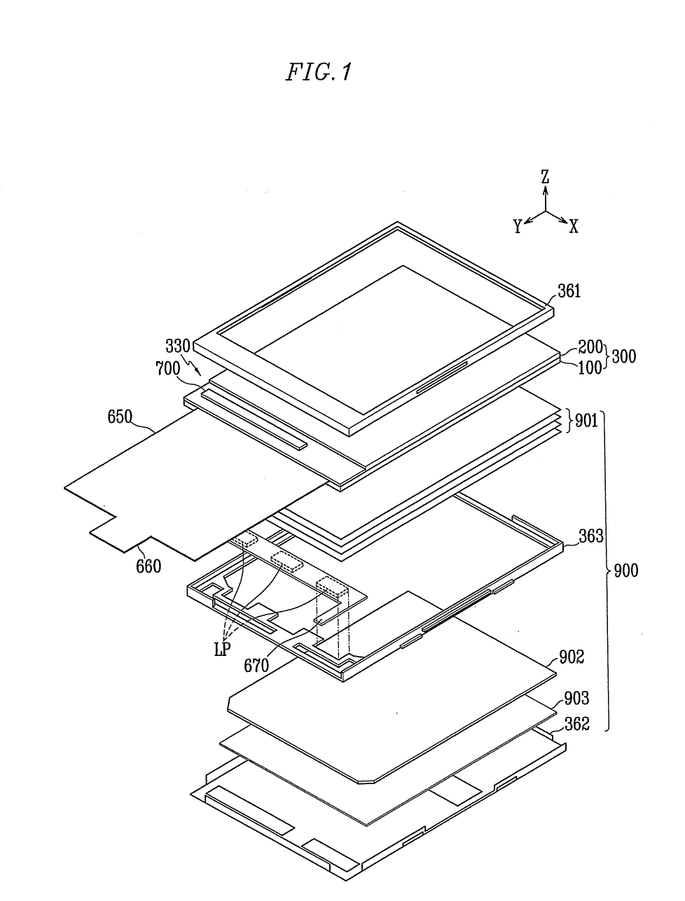

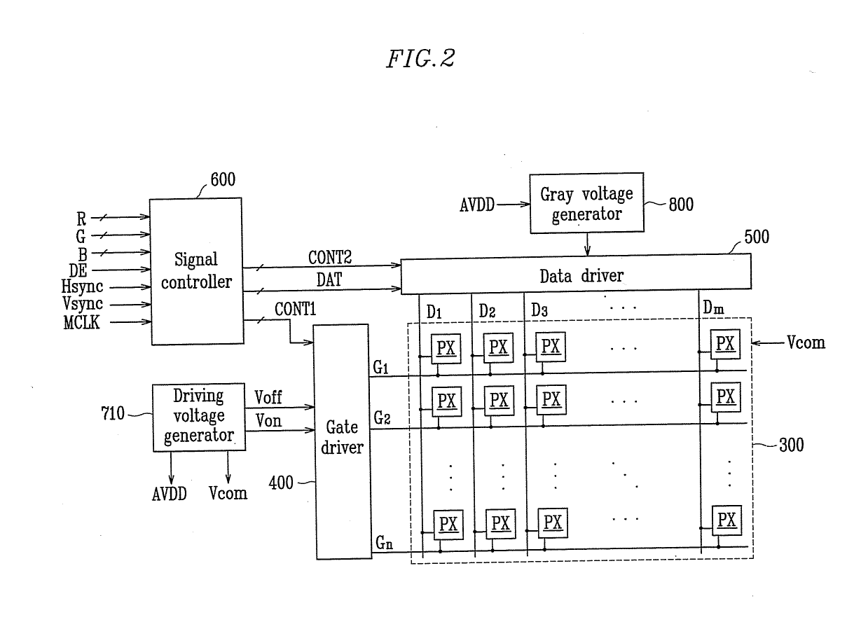

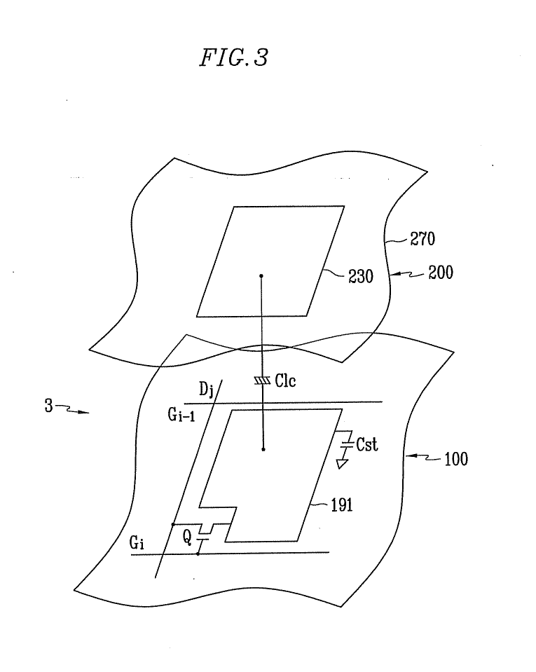

FIG. 1 is an exploded perspective view of the exemplary LCD according to an exemplary embodiment of the present invention, FIG. 2 is a block diagram of the exemplary LCD according to the exemplary embodiment of the present invention, and FIG. 3 is a diagram of an equivalent circuit for one exemplary pixel of the exemplary LCD according to the exemplary embodiment of the present invention.

As shown in FIG. 1, the LCD according to the exemplary embodiment of the present invention includes a liquid crystal module including a display panel part 330 and a backlight unit 900, upper and lower chassis 361 and 362 surrounding the liquid crystal module, and a molded frame 363 supporting the liquid crystal module.

The display panel part 330 includes a liquid crystal panel assembly 300, and a driving chip 700 and a flexible printed circuit board (“PCB”) 650 that are attached to the liquid crystal panel assembly 300.

As shown in FIG. 2 and FIG. 3, the liquid crystal panel assembly 300 includes a plurality of signal lines, and a plurality of pixels PX from the view of an equivalent circuit. As shown in FIG. 3, the liquid crystal panel assembly 300 includes lower and upper display panels 100 and 200 and a liquid crystal layer 3 provided between the upper and lower panels 100 and 200.

The signal lines are provided within the lower display panel 100, and include a plurality of gate lines G₁ to Gₙ for transmitting a gate signal (also referred to as a “scan signal”) and a plurality of data lines D₁ to Dₘ for transmitting a data voltage. The gate lines G1 to Gₙ substantially extend in a row direction, such as a first direction, and are parallel with one another, and the data lines D1 to Dₘ substantially extend in a column direction, such as a second direction, and are parallel with one another. The first direction may be substantially perpendicular to the second direction.

The pixels PX are arranged in a matrix format. In an exemplary embodiment, the pixel PX connected to an i-th gate line Gi (i=1, 2, . . . , n) and a j-th data line Gj (j=1, 2, . . . , m) includes a switching element Q and a liquid crystal capacitor Clc, and a storage capacitor Cst connected thereto. In alternative embodiments, the storage capacitor Cst may be omitted as necessary.

The switching element Q is a three terminal element such as a thin film transistor (“TFT”) that is provided in the lower display panel 100. A control terminal thereof, such as a gate electrode, is connected to the gate line Gi, an input terminal thereof, such as a source electrode, is connected to a data line Dj, and an output terminal thereof, such as a drain electrode, is connected to the liquid crystal capacitor Clc and the storage capacitor Cst.

The liquid crystal capacitor Clc may include a pixel electrode 191 of the lower display panel 100 and a common electrode 270 of the upper display panel 200 as two terminals, and the liquid crystal layer 3 between the two electrodes 191 and 270 functions as a dielectric material. The pixel electrode 191 is connected to the switching element Q, and the common electrode 270 may be formed on the entire surface, or substantially the entire surface, of the upper display panel 200 and has a common voltage Vcom applied thereto. In an alternative embodiment, unlike the structure shown in FIG. 3, the common electrode 270 may be provided on the lower display panel 100, and in this case, at least one of the two electrodes 191 and 270 may be formed in a linear or rod shape.

The storage capacitor Cst that supplements the liquid crystal capacitor Clc is formed such that an additional signal line (not shown) provided in the lower display panel 100 and the pixel electrode 191 overlap with an insulating material interposed therebetween, and the additional signal line is applied with a predetermined voltage such as a common voltage Vcom. However, the storage capacitor Cst may be formed by overlapping the pixel electrode 191 and a previous gate line formed directly on the pixel electrode with the insulating material therebetween.

Meanwhile, in order to perform color display, each pixel PX specifically displays one color in a set of colors (spatial division), or the pixels PX alternately display the colors over time (temporal division), which causes the colors to be spatially and temporally synthesized, thereby displaying a desired color. The colors may include primary colors, and may include red, green, and blue. As an example of the spatial division, FIG. 3 shows that each pixel PX has a color filter 230 for displaying one of the colors in a region of the upper display panel 200 corresponding to the pixel electrode 191. Alternatively, unlike the structure shown in FIG. 3, the color filter 230 may be provided above or below the pixel electrode 191 of the lower display panel 100.

At least one polarizer (not shown) for polarizing light may be mounted on an outer surface of the liquid crystal panel assembly 300. For example, the polarizer or polarizers adjust a transmission direction of light externally provided into the liquid crystal panel assembly 300 in accordance with an aligned direction of the liquid crystal layer 3.

Referring back to FIG. 1 and FIG. 2, the driving chip 700 includes a driving voltage generator 710, a gray voltage generator 800, a gate driver 400, a data driver 500, and a signal controller 600.

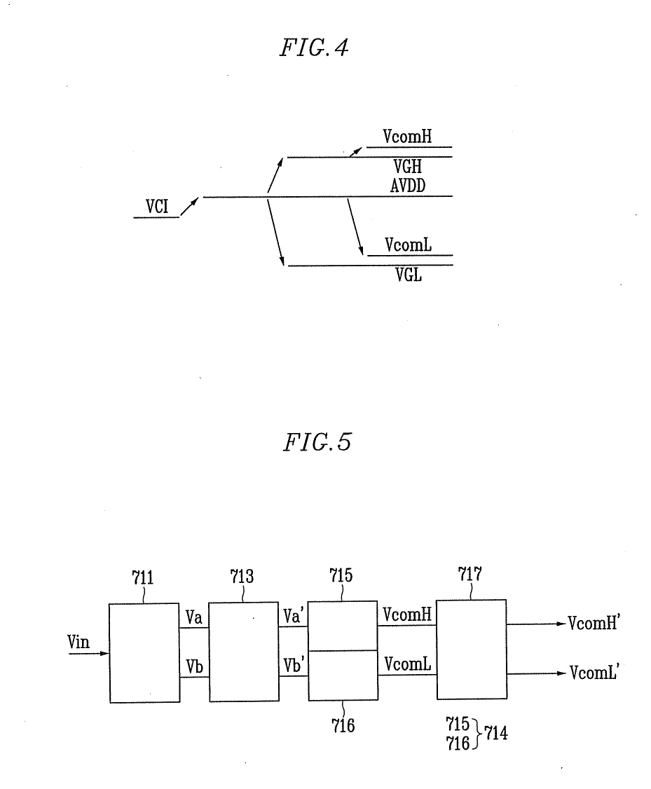

The driving voltage generator 710 according to the exemplary embodiment of the present invention will now be described with reference to FIG. 1 and FIG. 4.

FIG. 4 is a diagram representing voltage generation in the exemplary driving voltage generator 710 of the exemplary LCD according to the exemplary embodiment of the present invention.

As shown in FIG. 4, the driving voltage generator 710 receives a basic voltage VCI from a power supply of an external device (not shown) and boosts the basic voltage VCI to generate a voltage for driving the LCD. Generally, the basic voltage VCI is a voltage having a level that is higher than that of a ground voltage GND.

The driving voltage generator 710 first generates a first voltage AVDD. Subsequently, the driving voltage generator 710 boosts in a positive direction (+) or a negative direction (−) using the first voltage AVDD, to generate a second voltage VGH and a third voltage VGL. Then, first and second common voltages VcomH and VcomL are generated based on the generated voltages.

Here, various driving voltages are generated based on the first voltage AVDD, and are input to the gray voltage generator 800 to generate reference gray voltages.

The respective second and third voltages VGH and VGL are a gate-on voltage Von for turning on the switching element Q and a gate-off voltage Voff for turning off the switching element Q, and they form the gate signal to be applied to the gate lines G₁ to Gₙ.

The first and second common voltages VcomH and VcomL respectively have a maximum value and a minimum value of the common voltage Vcom, which is a cyclic signal.

In FIG. 4, it is illustrated that the first to third voltages AVDD, VGH, and VGL and the first and second common voltages VcomH and VcomL are generated based on the basic voltage VCI, but it is not limited thereto, and other voltages for driving the LCD may be generated. In addition, voltage variations shown in FIG. 4 may vary according to cases.

Referring back to FIG. 2, the gray voltage generator 800 generates all gray voltages relating to transmittance of the pixels PX or a limited number of gray voltages (hereinafter referred to as “reference gray voltages”) based on the reference voltage AVDD received from the driving voltage generator 710. The reference gray voltage may include the common voltage Vcom having a positive value, such as first common voltage VcomH, and the common voltage having a negative value, such as second common voltage VcomL.

The gate driver 400 is coupled to the gate lines G₁ to Gₙ of the liquid crystal panel assembly 300, receives the gate-on voltage Von and the gate-off voltage Voff from the driving voltage generator 710, such as the second voltage VGH and the third voltage VGL, combines the gate-on voltage Von and the gate-off voltage Voff to generate the gate signal, and applies the gate signal to the gate lines G₁ and Gₙ.

The data driver 500 is coupled to the data lines D₁ to Dₘ of the liquid crystal panel assembly 300, and it selects the gray voltage received from the gray voltage generator 800 and applies it as a data voltage to the data lines D₁ to Dₘ. However, when the gray voltage generator 800 does not provide all the gray voltages but provides the limited number of reference gray voltages, the data driver 500 divides the reference gray voltage and selects a desired data voltage.

The signal controller 600 controls the gate driver 400 and the data driver 500.

At least one of the drivers 400, 500, 600, 710, and 800 or at least one circuit forming the drivers 400, 500, 600, 710, and 800 may be formed outside an integrated chip (“IC”). In addition, the respective drivers 400, 500, 600, 710, and 800 may be directly mounted on the liquid crystal panel assembly 300 in a type of at least one integrated circuit chip, they may be mounted on a flexible printed circuit film (not shown) to be attached to the liquid crystal panel assembly 300 in a type of tape carrier package (“TCP”), or they may be mounted on an additional flexible PCB (not shown). Otherwise, the drivers 400, 500, 600, 710, and 800 may be integrated with the liquid crystal panel assembly 300 along with the signal lines G₁ to Gₙ and D₁ to Dₘ and the TFT switching element Q.

Referring back to FIG. 1, the flexible PCB 650 is mounted on one side of the liquid crystal panel assembly 300. The flexible PCB 650 includes a protruding portion 660 positioned on an opposite side of the liquid crystal panel assembly 300. The protruding portion 660 externally receives a signal, and the protruding portion 660 and the driving chip 700 are connected to each other by a signal line.

The molded frame 363 is provided between the upper chassis 361 and the lower chassis 362.

The backlight unit 900 includes a lamp LP, a circuit element (not shown) for controlling the lamp LP, a PCB 670, a light guide plate 902, a reflecting sheet 903, and a plurality of optical sheets 901.

The lamp LP is fixed to the PCB 670 positioned on an edge area of a side of the molded frame 363, and supplies light to the liquid crystal panel assembly 300.

The light guide plate 902 guides the light from the lamp LP toward the liquid crystal panel assembly 300, and causes the strength of the light to be uniform.

The reflecting sheet 903 is provided under the light guide plate 902, and reflects the light from the lamp LP to the liquid crystal panel assembly 300.

The optical sheet 901 is provided above the light guide plate 902, and secures luminescence characteristics of the light from the lamp LP.

The upper chassis 361 and the lower chassis 362 are combined with the molded frame 363 therebetween to include the liquid crystal module.

An operation of the LCD will now be described.

The signal controller 600 receives input video signals R, G, and B, and input control signals for controlling the input video signals R, G, and B from an external graphics controller (not shown). The input video signals R, G, and B include luminance information of each pixel PX, and the luminance has a predetermined number of grays (e.g., 1024 (=2¹⁰), 256 (=2⁸), or 64 (=2⁶)). The input control signals may include a vertical synchronization signal Vsync, a horizontal synchronization signal Hsync, a main clock signal MCLK, and a data enable signal DE.

The signal controller 600 appropriately processes the input video signals R, G, and B according to an operational condition of the liquid crystal panel assembly 300 based on the input video signals R, G, and B and the input control signals, generates a gate control signal CONT1 and a data control signal CONT2, transmits the gate control signal CONT1 to the gate driver 400, and transmits the data control signal CONT2 and a processed digital video signal DAT to the data driver 500.

The gate control signal CONT1 includes a scan start signal STV for starting a scan operation, and at least one clock signal for controlling an output period of a gate-on voltage Von. Further, the gate control signal CONT1 may include an output enable signal OE for limiting a duration time of the gate-on voltage Von.

The data control signal CONT2 includes a horizontal synchronizing start signal STH for informing transmission start of the digital video signal DAT for the pixel PX of one row, and a load signal LOAD and a data clock signal HCLK for applying an analog data voltage to the data lines D₁ to Dₘ. Further, the data control signal CONT2 may include an inversion signal RVS for inverting data voltage polarity with respect to the common voltage Vcom (hereinafter, the data voltage polarity with respect to the common voltage Vcom will be referred to as a “data voltage polarity”.)

According to the data control signal CONT2 from the signal controller 600, the data driver 500 receives the digital video signal DAT for the pixel PX of one row, selects a gray voltage corresponding to each digital video signal DAT, and converts the digital video signal DAT to an analog data voltage and applies it to the corresponding data lines D₁ to Dₘ.

The gate driver 400 applies the gate-on voltage Von to the gate lines G₁ to Gₙ according to the gate control signal CONT1 from the signal controller 600 to turn on the switching element Q coupled to the gate lines G₁ to Gₙ. Thereby, the data voltage applied to the data lines D₁ to Dₘ is applied to the corresponding pixel PX through the turned on switching element Q.

A difference between the data voltage applied to the pixel PX and the common voltage Vcom is expressed as a charged voltage of the liquid crystal capacitor Clc (i.e., a pixel voltage). An arrangement of liquid crystal molecules varies according to a size of the pixel voltage, and therefore polarized light penetrating the liquid crystal layer 3 varies. The variation of the polarized light is expressed as a transmittance variance of the light, and therefore the pixel PX expresses the luminance expressed by the grayscale of the video signals DAT.

The above operation is repeatedly performed having a horizontal period 1H corresponding to one period of the horizontal synchronization signal Hsync and the data enable signal DE, the gate-on voltage Von is sequentially applied to all the gate lines G₁ to G, and the data voltage is applied to all the pixels so as to display an image of one frame.

After one frame ends, a subsequent frame is started, and a state of the inversion signal RVS applied to the data driver 500 to invert the polarity of the data voltage applied to each pixel PX from the polarity of a previous frame is controlled, which is referred to as “frame inversion” In this case, in one frame, the polarity of the data voltage flowing through one data line may be periodically changed according to characteristics of the inversion signal RVS (e.g., row inversion and dot inversion), or the polarities of the data voltage applied to one pixel row may be different. (e.g., column inversion and dot inversion).

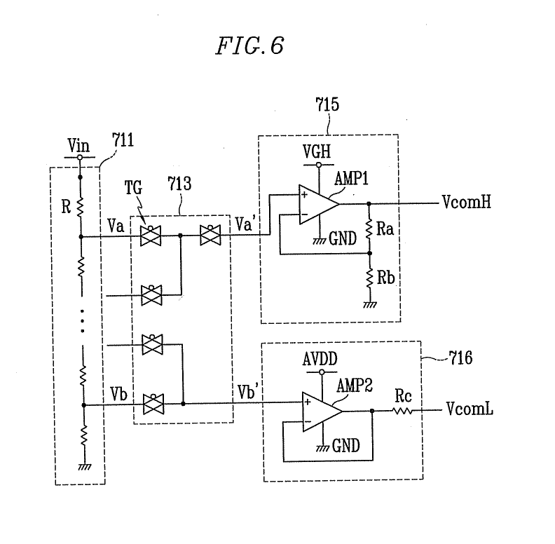

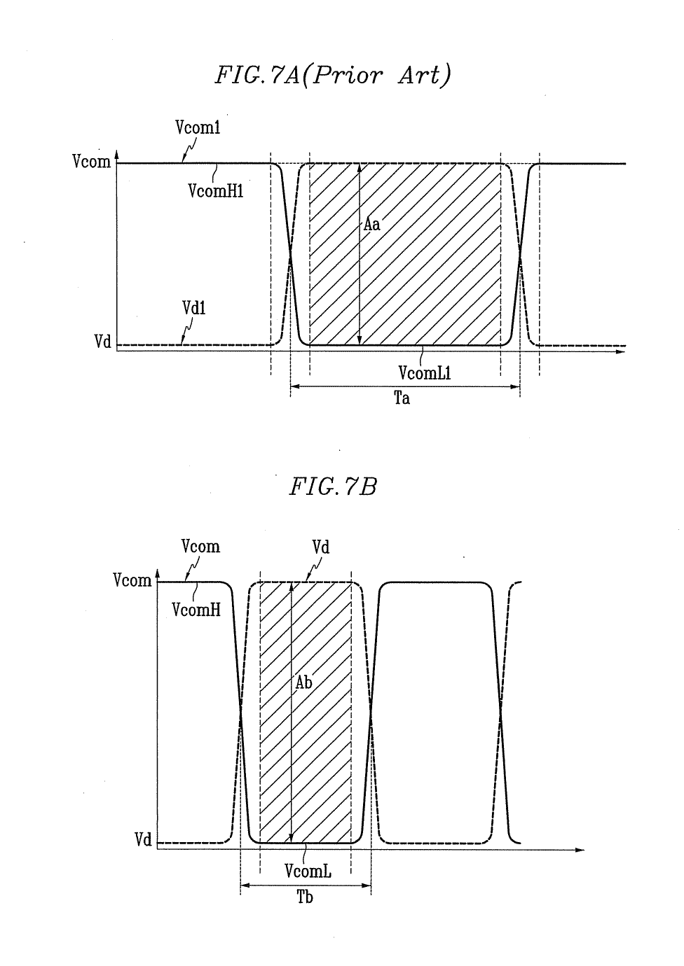

The driving voltage generator 710 according to exemplary embodiments of the present invention will be described with reference to FIG. 5 and FIG. 6.

FIG. 5 is a block diagram representing a part of the exemplary driving voltage generator according to the exemplary embodiment of the present invention, and FIG. 6 is a circuit diagram representing a part of the exemplary driving voltage generator according to the exemplary embodiment of the present invention.

As described above, the driving voltage generator 710 generates various voltages for driving the LCD. In FIG. 5 and FIG. 6, parts for generating the common voltage Vcom in the driving voltage generator 710 are illustrated.

As shown in FIG. 5 and FIG. 6, the driving voltage generator 710 of the LCD according to the exemplary embodiment of the present invention includes a voltage distribution unit 711, a controller 713, an output unit 714 having first and second output units 715 and 716, and a filter unit 717 that are sequentially connected.

The voltage distribution unit 711 generates a first reference voltage Va and a second reference voltage Vb based on an input voltage Vin. The input voltage Vin may be the basic voltage VCI shown in FIG. 4, and it may be one of the various driving voltages generated in the driving voltage generator 710.

The controller 713 controls values of the first and second reference voltages Va and Vb received from the voltage distribution unit 711, and outputs the values as first and second reference voltages Va′ and Vb′ that are controlled by the controller 713.

The output unit 714 includes the first and second output units 715 and 716 for respectively receiving the first and second reference voltages Va′ and Vb′ controlled by the controller 713. The first and second output units 715 and 716 generate first and second common voltages VcomH and VcomL based on the controlled first and second reference voltages Va′ and Vb′.

The filter unit 717 receives the first and second common voltages VcomH and VcomL from the first and second output units 715, 716, respectively, eliminates a noise from the first and second common voltages VcomH and VcomL, and outputs final first and second common voltages VcomH′ and VcomL′.

The part of the driving voltage generator shown in FIG. 5 will be described with reference to FIG. 6 in further detail.

As shown in FIG. 6, the voltage distribution unit 711 includes a resistor string including a plurality of resistors R coupled in series and connected between the input voltage Vin and ground, and the controller 713 includes a plurality of transmission gates TG.

The first output unit 715 includes a first operation amplifier AMP1 and first and second resistors Ra and Rb.

The first operation amplifier AMP1 includes a non-inversion input terminal (+), an inversion input terminal (−), and an output terminal. First and second power sources are applied to the first operation amplifier AMP1, a second voltage VGH is connected to the first power source, and a ground voltage is connected to the second power source.

The first resistor Ra is connected between the inversion input terminal (−) and the output terminal of the first operation amplifier AMP1, and the second resistor Rb is connected between the inversion input terminal (−) and the ground voltage of the first operation amplifier AMP1. The first resistor Ra and the second resistor Rb may be connected in series between the output terminal of the first operation amplifier AMP1 and ground.

The first output unit 715 receives the controlled first reference voltage Va′ from the controller 713, performs non-inversion amplification according to a ratio of the first and second resistors Ra and Rb within a range of the first and second power sources VGH and GND, and outputs the first common voltage VcomH. The first common voltage VcomH is given as Equation 1.

VcomH=Va′^{x}(1+Rb/Ra) [Equation 1]

As described, the first power source of the first operation amplifier AMP1 of the first output unit 715 is coupled to the second voltage VGH, and the second voltage VGH has a considerably high value since it is obtained by amplifying the basic voltage VCI, as previously described with respect to FIG. 4. Accordingly, an output range of the first common voltages VcomH output through the first output unit 715 is increased.

The second output unit 716 includes a second operation amplifier AMP2 and a third resistor Rc.

The second operation amplifier AMP2 includes a non-inversion input terminal (+), an inversion input terminal (−), and an output terminal, and the inversion input terminal (−) and the output terminal are connected to each other so that the second operation amplifier AMP2 forms a voltage follower. Third and fourth power sources are applied to the second operation amplifier AMP2, the first voltage AVDD is connected to the third power source, and the ground voltage is connected to the fourth power source.

The third resistor Rc is connected to the output terminal of the second operation amplifier AMP2. The third resistor Rc controls an output value of the second output unit 716, and may, in an alternative embodiment, be omitted.

The second output unit 716 receives the controlled second reference voltage Vb′ from the controller 713, and outputs it as the second common voltage VcomL.

In addition, the filter unit 717 is omitted in FIG. 6, and the controller 713 may also be omitted in alternative embodiments of the driving voltage generator 710.

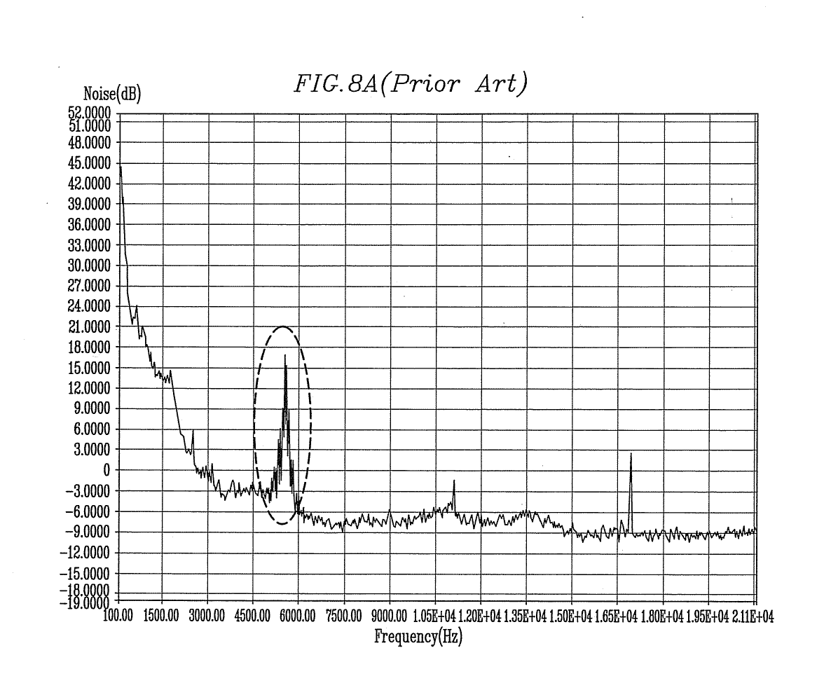

The common voltage Vcom of the LCD according to exemplary embodiments of the present invention will be described with reference to FIG. 7A and FIG. 7B.

FIG. 7A is a waveform diagram representing a common voltage Vcom1 and a data voltage Vd1 of the conventional LCD of the prior art, and FIG. 7B is a waveform diagram representing the common voltage Vcom and the data voltage Vd of the exemplary LCD according to the exemplary embodiment of the present invention.

As shown in FIG. 7A, the common voltage Vcom of the conventional LCD is a periodic signal including a high level common voltage VcomH1 and a low level common voltage VcomL1. As shown in FIG. 7B, the common voltage Vcom of the LCD according to the exemplary embodiment of the present invention is a periodic signal including a relatively high level first common voltage VcomH and a relatively low level second common voltage VcomL.

However, when comparing FIG. 7A and FIG. 7B, the first common voltage VcomH of the LCD according to the exemplary embodiment of the present invention is higher or greater than the high level common voltage Vcom H1 of the conventional LCD. Accordingly, an amplitude Ab of the common voltage Vcom of the LCD according to the exemplary embodiment of the present invention is greater than an amplitude Aa of the common voltage Vcom1 of the conventional LCD, where the amplitude is defined as a difference between the high level common voltage and the low level common voltage.

In addition, the data voltages Vd1 and Vd are periodic signals that swing with the same period as that of the common voltages Vcom1 and Vcom, and phases thereof are opposite to each other. Further, as described, the difference between the data voltages Vd1 and Vd applied to the pixel PX and the common voltages Vcom1 and Vcom is expressed as the charged voltage in the liquid crystal capacitor Clc (i.e., the pixel voltage). That is, in FIG. 7A and FIG. 7B, Ta and Tb are charging times, and oblique-lined parts indicate a charged amount of the liquid crystal capacitor Clc.

When the amplitude Ab of the common voltage Vcom is increased as shown in the LCD according to the exemplary embodiment of the present in invention of FIG. 7B, the oblique-lined part (i.e., the charged amount of the liquid crystal capacitor Clc) may be maintained to be similar to the charged amount of the liquid crystal capacitor Clc of FIG. 7A while the charging time Tb of the common voltage Vcom shown in FIG. 7B is reduced to be less than the charging time Ta of the common voltage Vcom1 shown in FIG. 7A. In addition, when the charging time Tb of the common voltage Vcom shown in FIG. 7B is reduced to be less than the charging timed of the common voltage Vcom1 shown in FIG. 7A, a frequency of the common voltage Vcom shown in FIG. 7B is increased to be greater than the frequency of the common voltage Vcom1 shown in FIG. 7A. As will be further described below, when the frequency is increased, a driving noise of an audible range is reduced in the LCD.

A frequency Fb of the common voltage Vcom is set to be greater than a 15 KHz frequency that may not be perceived as an audible noise. In addition, the first common voltage VcomH is set be within a range of 8V to 12V to sufficiently obtain the charged amount of the liquid crystal capacitor Clc and set the frequency to be greater than an audible frequency.

As described, since the amplitude Ab of the common voltage Vcom is increased and the frequency is increased in the LCD according to the exemplary embodiment of the present invention, the charged amount of the liquid crystal capacitor Clc may be sufficiently obtained while the driving noise may be reduced.

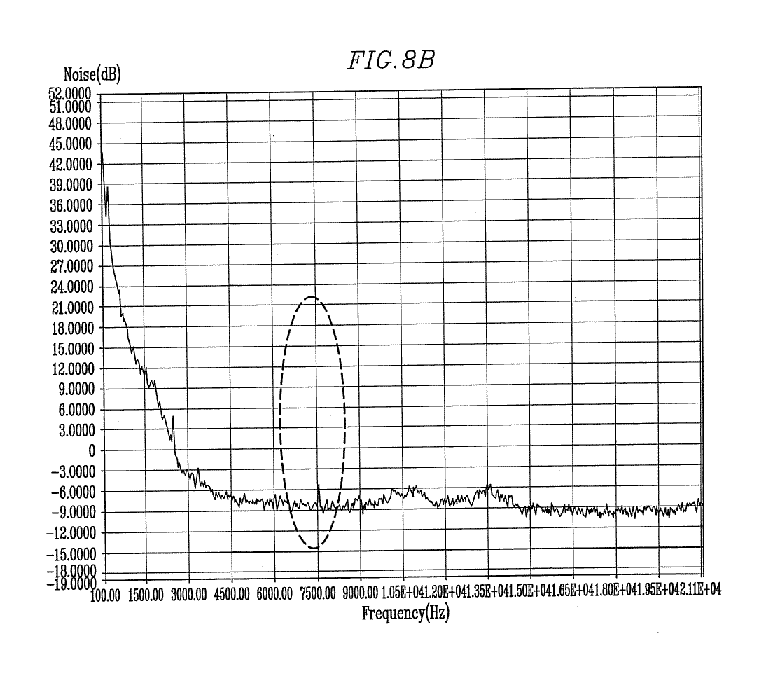

An effect of the LCD according to the exemplary embodiment of the present invention will be described with reference to FIG. 8A and FIG. 8B.

FIG. 8A is a graph representing noise according to the audible frequency in the conventional LCD to which the common voltage Vcom1 shown in FIG. 7A is applied, and FIG. 8B is a graph representing noise according to the audible frequency in the exemplary LCD to which the common voltage Vcom shown in FIG. 7B is applied.

In the conventional LCD, the noise is considerably increased in the audible frequencies 4500 Hz to 6000 Hz shown as a dotted circle in FIG. 8A. However, in the LCD according to the exemplary embodiment of the present invention, the noise is not increased in any audible frequency.

According to the exemplary embodiment of the present invention, since the driving noise of the LCD is prevented, a noise problem caused in a slim mobile phone may be solved. Using the exemplary LCD according to the present invention, a method of preventing driving noise of the LCD is also provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of pixels to which a common voltage is applied, the common voltage being a periodic signal comprising a first common voltage and a second common voltage that is lower than the first common voltage; and
a driving voltage generator which generates first and second voltages from a received basic voltage, generates the first common voltage based on the basic voltage and the second voltage, and generates the second common voltage based on the basic voltage and the first voltage,
wherein the driving voltage generator comprises a voltage distribution unit which divides the basic voltage and outputs first and second reference voltages, a first output unit which amplifies the first reference voltage and generates the first common voltage, and a second output unit which outputs the second common voltage based on the second reference voltage, and
the first output unit comprises an operation amplifier connected to a first power source, and the second voltage is applied to the first power source.

2. The display device of claim 1, wherein a pixel among the plurality of pixels comprises a pixel electrode and a thin film transistor connected to the pixel electrode, the thin film transistor is turned on by receiving a gate signal including a gate-on voltage, and a data voltage is transmitted to the pixel electrode through the thin film transistor.

3. The display device of claim 2, wherein the second voltage is the gate-on voltage.

4. The display device of claim 3, wherein the driving voltage generator generates a third voltage from the received basic voltage, and the third voltage is a gate-off voltage.

5. The display device of claim 2, further comprising:
a gray voltage generator which generates a reference gray voltage from the first voltage; and
a data driver which selects a gray voltage from the reference gray voltage to generate the data voltage.

6. The display device of claim 1, further comprising a first resistor connected between an output terminal and an inversion input terminal (−) of the operation amplifier, and a second resistor connected between the inversion input terminal (−) and a ground terminal of the operation amplifier.

7. The display device of claim 6, further comprising a controller controlling the first and second reference voltages output from the voltage distribution unit, and respectively transmitting controlled first and second reference voltages to the first and second output units, wherein the first common voltage is defined by:
VcomH=Va′^{x}(1+Rb/Ra)
where VcomH is the first common voltage, Va′ is the controlled first reference voltage, Rb is the second resistor, and Ra is the first resistor.

8. The display device of claim 6, wherein the first output unit receives the first reference voltage controlled by a controller, performs non-inversion amplification according to a ratio of the first and second resistors within a range of the first power source and a grounded second power source, and outputs the first common voltage.

9. The display device of claim 1, wherein the operation amplifier is connected to a second power source, and the second power source is grounded.

10. The display device of claim 1, wherein the second output unit comprises a voltage follower.

11. The display device of claim 10, wherein the voltage follower is connected to third and fourth power sources, the first voltage is applied to the third power source, and the fourth power source is grounded.

12. The display device of claim 1, wherein the voltage distribution unit comprises a resistor string comprising a plurality of resistors.

13. The display device of claim 1, further comprising a controller which controls the first and second reference voltages output from the voltage distribution unit, and respectively transmits controlled first and second reference voltages to the first and second output units.

14. The display device of claim 13, wherein the controller comprises a plurality of transmission gates.

15. The display device of claim 1, further comprising a filter unit connected to at least one of the first and second output units.

16. The display device of claim 1, wherein a frequency of the common voltage is greater than about 15 KHz.

17. The display device of claim 1, wherein the first common voltage is set to be within a range of about 8V to about 12V.

18. The display device of claim 1, wherein the driving voltage generator boosts, in a positive direction, the first voltage to generate the second voltage.

19. A method of substantially preventing driving noise of a display device, the method comprising:
applying a common voltage to a plurality of pixels, the common voltage being a periodic signal including a first common voltage and a second common voltage lower than the first common voltage, and having a frequency greater than about 15 KHz.

20. The method of claim 19, further comprising, prior to applying the common voltage to the plurality of pixels:
generating first and second voltages from a basic voltage received by a driving voltage generator, the second voltage boosted in a positive direction from the first voltage;
dividing the basic voltage and outputting first and second reference voltages from a voltage distribution unit;
amplifying the first reference voltage in a first output unit with an operation amplifier connected to a first power source, the second voltage applied to the first power source;
outputting the first common voltage from the first output unit; and
outputting the second common voltage based on the second reference voltage from a second output unit.
